(19) United States
(12) Patent Application Publication
(10) Pub. No.: US 2013/0312655 A1
(43) Pub. Date: Nov. 28, 2013

(54) MOUTHGUARD APPARATUS AND METHOD FOR SENSING BODY OVERHEATING

(71) Applicants: Gerald Gravelle, Hamilton (CA); Daniel Nossey, Hamilton (CA)

(72) Inventors: Gerald Gravelle, Hamilton (CA); Daniel Nossey, Hamilton (CA)

(21) Appl. No.: 13/481,902

(22) Filed: May 28, 2012

Related U.S. Application Data
(60) Provisional application No. 61/651,038, filed on May 24, 2012.

(51) Int. Cl. G01K 1/02; A61C 7/36

(52) U.S. Cl. 116/216; 264/16

(57) ABSTRACT

In combination a mouth guard and a temperature sensor which includes a plastic molded mouth guard including a mouth portion, a bite portion and a gum shield. The mouth guard molded with a dispersion of an over temperature color plastic and a normal color plastic, such that the mouth guard displays a combination of the normal color and the over temperature color. The normal color plastic contains a thermo chromatic ink based coloring which transforms the normal color portion of the dispersion to second color at a preselected transformation temperature. The transformation temperature is selected to indicate over heating of the human body by transformation of the mouth guard from the combination of the normal color and the over temperature color to a combination of the second color and the over temperature color.

This application claims priority from previously filed U.S. provisional patent application 61/651,038 filed May 24, 2012 by Gerald Gravelle and Daniel Nossey under the title MOUTH GUARD APPARATUS AND METHOD FOR SENSING BODY OVERHEATING.

### FIELD OF THE INVENTION

The present invention relates to protective mouth guards used in sporting activities and more particularly relates to a protective mouth guard which has the ability to indicate a body over temperature condition.

### BACKGROUND OF THE INVENTION

A mouth guard is a protective device for the mouth that covers the teeth and gums to prevent and reduce injury to the teeth, arches, lips and gums. Mouth guards are most often used to prevent injury in contact sports and are also called by other commonly used terms such as mouth protector, mouth piece, gum shield, gum guard. Mouth guards are used in sports where deliberate or accidental impacts of the face and jaw may cause harm. Such impacts may occur in many sports including baseball, boxing, mixed martial arts, rugby, wrestling, football, soccer, Australian football, lacrosse, basketball, ice hockey, field hockey, water polo, skiing and snowboarding to mention a few. Mouth guards may also prevent or reduce harm levels of a concussion in the event of injury to the jaw. In many sports the rules of the sport make the use of a protective mouth guard compulsory and/or local health law demands them. Schools also often have rules requiring their use.

Traditionally the sole purpose of the mouth guard has been to protect the mouth, gums and jaw area in the case of an impact. The current concept contemplates a dual use for the protective mouth guard namely the traditional use of the mouth guard and in addition the mouth guard would also function to warn and/or indicate when the player is in an overheated condition.

Heat illness of heat related illness is a spectrum of disorders due to environmental heat exposure. It includes minor conditions such as heat cramps and heat exhaustion as well as the more severe condition known as heat stroke. Heat stroke is defined as a body temperature of greater than 105.1 degrees Fahrenheit due to environmental heat exposure with lack of thermal regulation. This is distinct from a fever where there is a physiological increase in the temperature set point of the body.

Heat exhaustion can be a precursor of heat stroke and the symptoms include heavy sweating rapid breathing and a fast and weak pulse. Heat exhaustion can occur when the body is somewhere between 105.1 degrees Fahrenheit at the upper end and at normal temperature at the lower end.

Athletes taking part in high impact sports requiring the use of mouth guards often are also exposed to the potential for heat illness, heat exhaustion and also heat stroke due to the environmental conditions of the game. Many athletes wear heavy equipment including helmets which prevents the body from carrying out proper thermal regulations and at times body temperatures can rise dangerously high to the point where the player may suffer from heat illness, heat exhaustion and in an extreme case heat stroke wherein the body temperature rises above 105.1 degrees Fahrenheit.

### SUMMARY OF THE INVENTION

The concept is shown in the figures and particularly referring to FIGS. 6 and 7 the concept is a combination of a mouth guard and a temperature sensor comprising;
a) a plastic molded mouth guard including a mouth portion, a bite portion and a gum shield shown as 402,
b) the mouth guard molded with a dispersion of an over temperature color plastic and a normal color plastic, such that the mouth guard displaying a combination of the normal color and the over temperature color shown as 404;
c) wherein the normal color plastic contains a thermo chromatic ink based coloring which transforms the normal color portion of the dispersion to second color at a preselected transformation temperature shown as 406,
d) wherein the transformation temperature is selected to indicate over heating of the human body by transformation of the mouth guard from the combination of the normal color and the over temperature color to a combination of the second color and the over temperature color shown as 408.

Preferably wherein the normal color plastic contains a thermo chromatic ink based coloring which transforms the normal color portion of the dispersion to clear at a preselected transformation temperature wherein the transformation temperature is selected to indicate over heating of the human body by transformation of the mouth guard from the combination of the normal color and the over temperature color to the over temperature color shown as 502.

Preferably wherein the normal color selected to be black shown as 504.

Preferably wherein the amount of black consisting of about 2 to 25% by weight such that the combination of the normal color and over temperature color appears grey shown as 506.

Preferably wherein the transformation temperature selected to fall within the range 102° F. to 105° F. shown as 508.

A method of manufacturing a mouth guard comprising the steps of:
a) select an over temperature color for display of an overheating condition,
b) select a normal color made from a thermo chromatic ink;
c) select a transformation temperature which is the temperature at which the normal color transforms to a second color,
e) mold a mouth guard in plastic with a dispersion of over temperature color and normal color such that the mouth guard will display combination of normal color and over temperature color below the transformation temperature and the mouth guard will display a combination of the second color and the over temperature color above the transformation temperature.

Preferably wherein the normal color plastic contains a thermo chromatic ink based coloring which transforms the normal color portion of the dispersion to clear at a preselected transformation temperature wherein the transformation temperature is selected to indicate over heating of the human body by transformation of the mouth guard from the combination of the normal color and the over temperature color to the over temperature color.

Preferably wherein the normal color selected to be black.

Preferably wherein the amount of black consisting of about 2 to 25% by weight such that the combination of the normal color and over temperature color appears grey.

Preferably wherein the transformation temperature selected to fall within the range 102° F. to 105° F.

### BRIEF DESCRIPTION OF THE DRAWINGS

The concept will now be described by way of example only with references to the following drawings in which:

FIG. 1 is a top plan view of a mouth guard.

FIG. 2 is a side elevational view of a mouth guard.

FIG. 3 is a bottom plan view of a mouth guard.

FIG. 4 is a flowchart showing the steps to make a temperature sensing mouth guard.

FIG. 5 is a flowchart showing a specific steps to make a temperature sensing mouth guard.

FIG. 6 is a flowchart showing an example of a temperature sensing mouth guard.

FIG. 7 is a flowchart showing an example of a temperature sensing mouth guard.

### DETAILED DESCRIPTION OF THE PREFERRED EMBODIMENTS

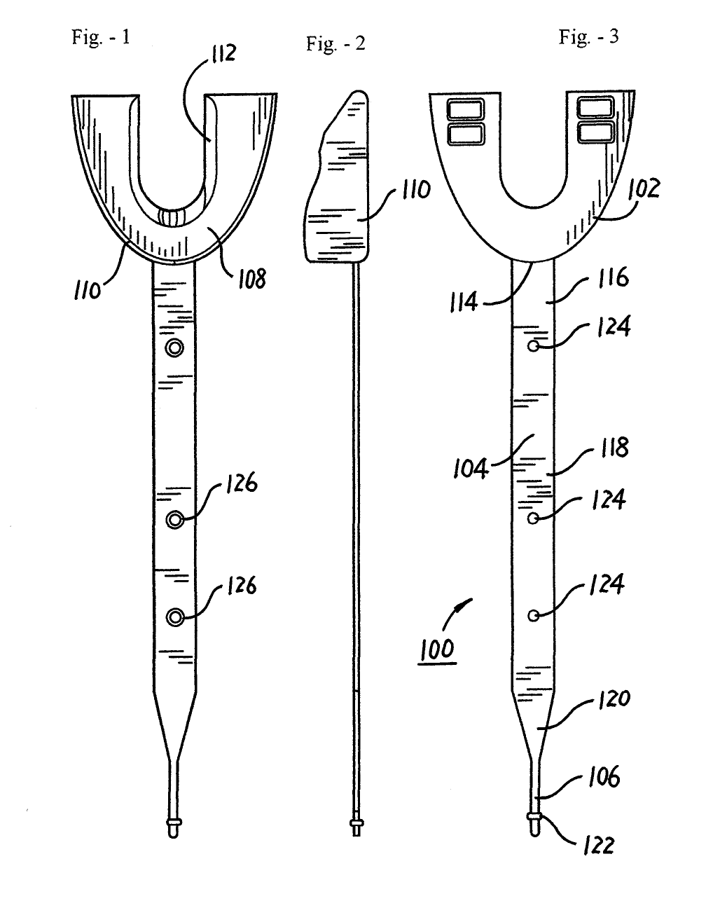

The present concept a mouth guard apparatus and method for sensing body overheating includes a mouth guard shown generally as 100 in FIGS. 1 through 3 which includes a mouth portion 102, a strap 104 which further includes a tie 106.

Mouth portion 102 includes a bite portion 108, a gum shield 110 and an inner rib 112.

Strap 104 is connected to mouth portion 102 at connection 114. Strap 104 further includes a top portion 116, a mid-portion 118, bottom portion 120, which includes the tie 106 and a tie collar 122.

Tie 106 is dimensioned to fit through tie holes 124 however tie collar 122 is dimensioned to interferingly fit through tie hole 124. Tie holes 124 further preferably include a hole relief 126 to ensure that tie collar 122 fits interferingly through tie hole 124 by aggressively pulling tie 106 through tie hole 124.

The mouth guard 100 depicted in FIGS. 1, 2 and 3 is the type that includes a strap 104. The strap portion is there simply to fasten releasably the strap 104 to a face guard of a helmet for example in football. By looping around strap 104 such that tie 106 is fed through one of the tie holes 124 such that tie collar 122 is urged through tie hole 124 thereby releasably fastening the bottom portion 120 of strap 104 to whatever portion of the helmet the player desires. Normally there is a wire mesh and/or a wire brace along the face guard portion of the helmet to which strap 104 can be connected to using tie 106. In this manner when a player removes the mouth portion 102 of mouth guard 100 the mouth guard is retained onto the helmet of the athlete.

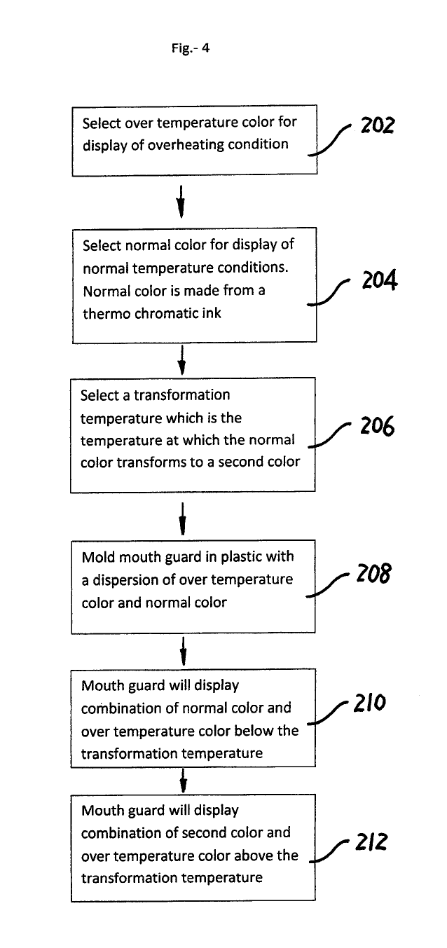

Referring now to FIG. 4 which shows the steps for the manufacture of a temperature indicating mouth guard as follows.

One would select the over-temperature colour for display of overheating condition shown as 202.

Next one would select a normal colour for display of normal temperature conditions. The normal colour is made from a thermal-chromatic ink. Shown as 204.

Select a transformation temperature which is the temperature at which the normal colour transforms to a second color which often is selected to be clear or color less which is shown as 206.

The mouth guard is molded in plastic with a dispersion of normal colour disbursed within over-temperature colour the shown as 208.

The mouth guard will display a combination of normal colour and over-temperature colour below the transformation temperature shown as 210.

The mouth guard will display a combination of the second color and over-temperature colour when the mouth guard is above the transformation temperature shown as 212.

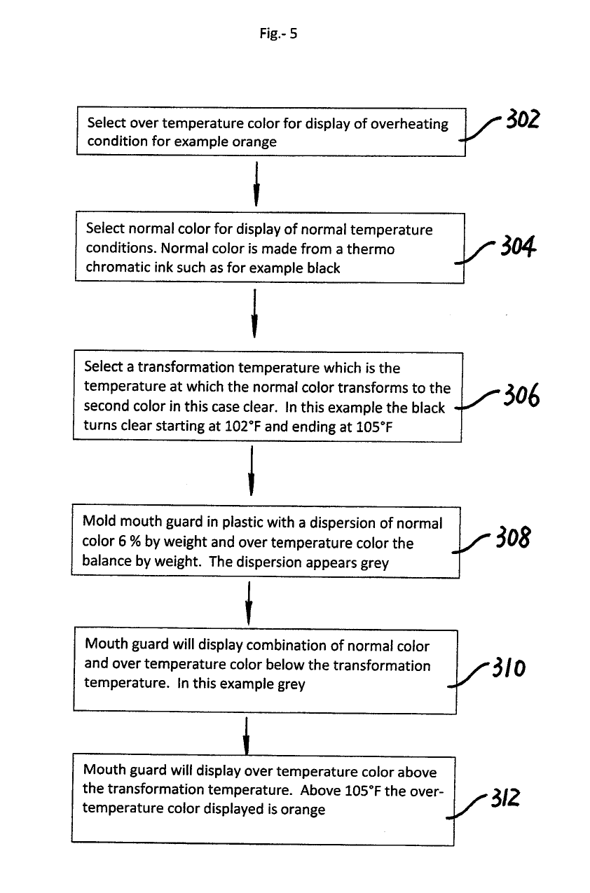

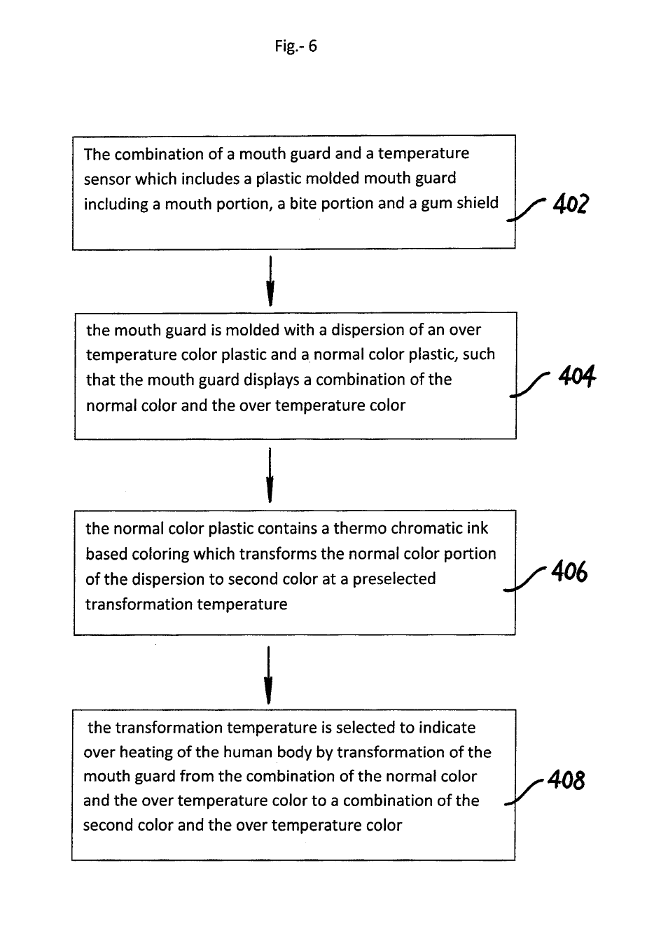

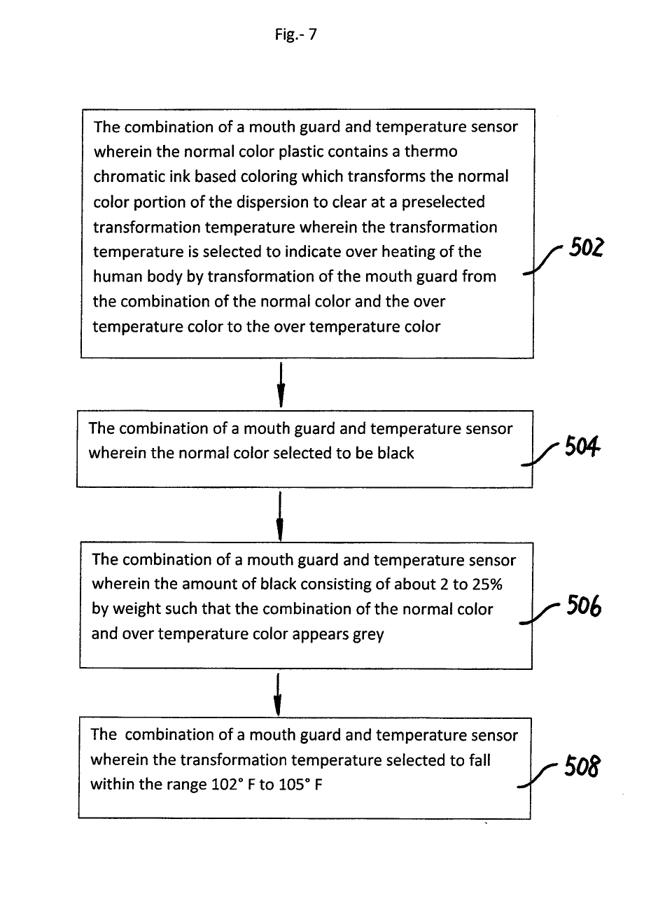

Referring now to FIG. 5 which shows an example of how this could be put in practice. A method of manufacturing temperature indicating mouth-guards is as follows.

Select an over-temperature colour for display of overheating condition for example in this case we would select the colour orange as shown in 302.

Select normal colour for display of normal temperature conditions. Normal colour is made from a thermo-chromatic ink which in this example would be the colour black as shown in 304.

Select a transformation temperature which is the temperature at which the normal colour transforms to the second color which in this example is clear. In this example the black chromatic ink would turn to clear starting at around 102 degrees Fahrenheit and ending at 105 degrees Fahrenheit as shown as 306.

Mould the mouth guard in plastic with a dispersion of normal colour in the amount of 6 per cent by weight and over temperature colour being the balance by weight. The dispersion appears grey shown as 308.

The mouth guard will display a combination of the normal colour and the over temperature colour below the transformation temperature which in this example is the colour grey which is a combination of 6 per cent black and balance orange as shown in 310.

The mouth guard will display an over-temperature colour above the transformation temperature which in this case is between 102 and 105 degrees Fahrenheit. Above 105 degrees Fahrenheit the over-temperature colour in this example is orange as shown in 312.

Mouth guard 100 functions not only as a mouth guard but also as a temperature sensor. The mouth guard is molded with a dispersion of an over temperature color plastic and a normal color plastic, such that the mouth guard displays a combination of the normal color and the over temperature color. Ethylene Vinyl Acetate and polyethylerne are typical plastics used for this application.

The normal color plastic contains a thermo chromatic ink based coloring which transforms the normal color portion of the dispersion to second color at a preselected transformation temperature. The second color is often selected to be clear.

The transformation temperature is selected to indicate over heating of the human body by transformation of the mouth guard from the combination of the normal color and the over temperature color to a combination of the second color and the over temperature color.

In practice the normal color plastic contains a thermo chromatic ink based coloring which transforms the normal color portion of the dispersion to clear at a preselected transformation temperature wherein the transformation temperature is selected to indicate over heating of the human body by transformation of the mouth guard from the combination of the normal color and the over temperature color to the over temperature color.

In many instances the normal color selected to be black since black will dominate the over temperature color. The amount of black required usually amounts to about 2 to 25% by weight such that the combination of the normal color and over temperature color appears grey.

The transformation temperature is normally not a single temperature but rather chromatic inks generally speaking transform over a small range of temperatures. In this case the transformation temperature is selected to lie between 102 and 105 degrees Fahrenheit and preferably the transformation temperature is selected such that the transformation is 100 per cent complete by the time the mouthguard reaches 105 degrees Fahrenheit. This temperature range is chosen since heat stroke is defined as a body temperature of greater than 105.1 degrees Fahrenheit. Therefore one would want the mouth guard to display a distinctive over-temperature colour when the mouth guard reaches 105 degrees Fahrenheit.

In practice the mouth guard begins to change colour from grey to a mottled grey/orange combination starting at a 102 degrees Fahrenheit which is above the normal body temperature which is defined as 99.6 degrees Fahrenheit.

As the temperature of the mouth guard climbs from 102 degrees Fahrenheit to 105 degrees Fahrenheit the appearance of the mouth guard becomes a deeper and more distinctive orange until the mouth guard is entirely orange in colour indicating that the athlete may be in danger of suffering heat stroke.

A person skilled in the art will note that any particular over-temperature colour other than orange can be selected however for this example orange was used. In addition any other normal temperature condition colour can be used other than black however in this example a small amount of black together with orange creates a grey appearance such that above the transformation temperature the mouth guard clearly changes to a different colour.

Additionally it is possible to choose other temperature ranges for transformation namely other transformation temperatures however in this case the temperature range 102 to 105 degrees Fahrenheit was chosen due to its significance regarding heat illness, heat exhaustion and heat stroke in humans.

The person skilled in the art will note that once the mouth guard has reached a particular colour the player and/or the team manager can take certain action to ensure that heat stroke and/or heat exhaustion is avoided and the player is given an opportunity to recover from excessive overheating.

It should be apparent to persons skilled in the arts that various modifications and adaptation of this structure described above are possible without departure from the spirit of the invention the scope of which defined in the appended claim.

I claim:

1. In combination a mouth guard and a temperature sensor comprising;
a) a plastic molded mouth guard which includes a mouth portion, a bite portion and a gum shield;
b) the mouth guard molded with a dispersion of an over temperature color plastic and a normal color plastic, such that the mouth guard displays a combination of the normal color and the over temperature color;
c) wherein the normal color plastic contains a thermo chromatic ink based coloring which transforms the normal color portion of the dispersion to second color at a preselected transformation temperature;
d) wherein the transformation temperature is selected to indicate over heating of the human body by transformation of the mouth guard from the combination of the normal color and the over temperature color to a combination of the second color and the over temperature color.

2. The combination claimed in claim 1 wherein the normal color plastic contains a thermo chromatic ink based coloring which transforms the normal color portion of the dispersion to clear at a preselected transformation temperature wherein the transformation temperature is selected to indicate over heating of the human body by transformation of the mouth guard from the combination of the normal color and the over temperature color to the over temperature color.

3. The combination claimed in claim 2 wherein the normal color is selected to be black.

4. The combination claimed in claim 3 wherein the amount of black consisting of about 2 to 25% by weight such that the combination of the normal color and over temperature color appears grey.

5. The combination claimed in claim 4 wherein the transformation temperature selected to fall within the range 102° F. to 105° F.

6. A method of manufacturing a mouth guard comprising the steps of:
a) select an over temperature color for display of an overheating condition,
b) select a normal color made from a thermo chromatic ink;
c) select a transformation temperature which is the temperature at which the normal color transforms to a second color,
e) mold a mouth guard in plastic with a dispersion of over temperature color and normal color such that the mouth guard will display combination of normal color and over temperature color below the transformation temperature and the mouth guard will display a combination of the second color and the over temperature color above the transformation temperature.

7. The method claimed in claim 6 wherein the normal color plastic contains a thermo chromatic ink based coloring which transforms the normal color portion of the dispersion to clear at a preselected transformation temperature wherein the transformation temperature is selected to indicate over heating of the human body by transformation of the mouth guard from the combination of the normal color and the over temperature color to the over temperature color.

8. The method claimed in claim 7 wherein the normal color selected to be black.

9. The method claimed in claim 8 wherein the amount of black consisting of about 2 to 25% by weight such that the combination of the normal color and over temperature color appears grey.

10. The method claimed in claim 9 wherein the transformation temperature selected to fall within the range 102° F. to 105° F.
